(19) United States
(12) Patent Application Publication
(10) Pub. No.: US 2026/0103040 A1
(43) Pub. Date: Apr. 16, 2026

(54) ACTIVE SUSPENSION POWER SUPPLY CONTROL

(71) Applicant: JAGUAR LAND ROVER LIMITED, Coventry (GB)

(72) Inventors: Balazs KOBOR, Coventry (GB); Emil NAGY, Coventry (GB); Rishi RASTOGI, Coventry (GB); Rakshit THUKRAL, Coventry (GB); Balazs OFFNER, Coventry (GB); Craig WARING, Coventry (GB); Michael RODLEY, Coventry (GB); Jozsef PAZMANY, Coventry (GB)

(21) Appl. No.: 18/917,631

(22) Filed: Oct. 16, 2024

(51) Int. Cl. B60G 17/0195; B60G 17/015; B60G 21/055

(52) U.S. Cl. CPC B60G 17/0195; B60G 17/0157; B60G 21/0558; B60G 2400/732; B60G 2600/73

(57) ABSTRACT

Aspects and embodiments of the invention relate to a control system for controlling an electronic active roll control power supply, a vehicle comprising the control system, a corresponding method of controlling an electronic active roll control power supply, and corresponding computer readable instructions. The control system comprises one or more processors which are collectively configured to: output at least one control signal to control charging of the electronic active roll control power supply from a vehicle power supply; receive a signal indicative of a vehicle operating temperature; determine whether the vehicle operating temperature is below a threshold; and in dependence on determining that the vehicle operating temperature is below a threshold, cause a charging of the electronic active roll control power supply to be delayed until engine cranking, powered by the vehicle power supply, is complete.

### TECHNICAL FIELD

The present disclosure relates to control of an active suspension power supply. Some examples relate to control of a power supply for electronic active roll control.

Aspects of the invention relate to a control system, a non-transitory computer-readable medium, an electronic active roll control power supply system, a vehicle, and a method of controlling an electronic active roll control power supply.

### BACKGROUND

Electronic active roll control applies anti-roll torque to front and rear stabilisers using electromechanical actuators. The anti-roll torque applied is a dynamic response to counter the body roll of a vehicle caused by, for example, lateral acceleration or wheel disturbance, which may result from fast cornering or travel over road irregularities. The load demand of the actuators has high peaks and is highly transient. A dedicated power supply for the electronic active roll control can be used to manage the load demand and provide a buffer between this load demand and the vehicle power supply so that power supply to other vehicle subsystems is not detrimentally affected.

It is an aim of the present invention to address one or more of the disadvantages associated with the prior art.

### SUMMARY OF THE INVENTION

Aspects and embodiments of the invention provide a control system for controlling an electronic active roll control power supply, an electronic active roll control power supply system, a vehicle, a method of controlling an electronic active roll control power supply, and a non-transitory computer readable medium comprising computer readable instructions as claimed in the appended claims.

According to an aspect of the present invention there is provided a control system for controlling an electronic active roll control power supply, the control system comprising one or more processors collectively configured to: output at least one control signal to control charging of the electronic active roll control power supply from a vehicle power supply; receive a signal indicative of a vehicle operating temperature; determine whether the vehicle operating temperature is below a threshold; and, in dependence on determining that the vehicle operating temperature is below a threshold, cause a charging of the electronic active roll control power supply to be delayed until engine cranking, powered by the vehicle power supply, is complete.

When the vehicle is operated at low temperatures, due to low temperatures causing a reduction in the overall capacity of the vehicle power supply and an increase in the energy needed to crank the engine, engine cranking may lead to a severe voltage drop for an electronic active roll control power supply or alternatively, charging the electronic active roll control power supply may lead to a voltage drop for the engine starter. To avoid loss of power to the electronic active roll control system as a result of the engine cranking or difficulties in starting the engine, the inventors have determined that when a vehicle operating temperature is below a threshold, charging of the electronic active roll control power supply is to be delayed until engine cranking is complete.

Further, as repeated engine cranking, may be needed to start the engine at low temperature, it may cause repeated voltage drops. Safety measures may cause repeated voltage drops to be treated as a fault. To prevent these faults, the inventors have determined that when a vehicle operating temperature is below a threshold, charging of the electronic active roll control power supply is to be delayed until engine cranking is complete.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to: output at least one control signal to control charging of the electronic active roll control power supply from a vehicle power supply; receive a signal indicative of a vehicle operating temperature; determine whether the vehicle operating temperature is below a threshold; and, in dependence on determining that the vehicle operating temperature is below a threshold, cause a charging of the electronic active roll control power supply to be delayed until engine cranking, powered by the vehicle power supply, is complete.

Optionally, the electronic active roll control power supply comprises at least one electrical energy storage module, the at least one electrical energy storage module being configured as a power buffer for one or more active roll stabilisers.

A power buffer functions to decouple downstream loads from an upstream power source and provides a temporary store of energy drawn from the upstream power source which can be released to meet the downstream load demand on-demand.

The at least one electrical energy storage module may help to manage transient loads and may help to manage the situations where the power supplied by the vehicle power supply and the one or more active roll stabilisers'load demand are mismatched.

Optionally, the electronic active roll control power supply further comprises a voltage converter, the voltage converter being connected between the vehicle power supply and the at least one electrical energy storage module.

The voltage converter may enable an input voltage from the vehicle power supply to be stepped up so that the electronic active roll control power supply has a higher power density and can meet sudden, large power demands from the one or more active roll stabilisers.

Optionally, causing the charging of the electronic active roll control power supply to be delayed may comprise isolating or maintaining isolation of the at least one electrical energy storage module from the vehicle power supply.

Optionally, causing the charging of the electronic active roll control power supply to be delayed may comprise placing or maintaining the voltage converter in a standby state.

Optionally, the at least one control signal output to control charging of the electronic active roll control power supply from the vehicle power supply may comprise a control signal to provide a current path between the vehicle power supply and the at least one electrical energy storage module.

Optionally, the control signal may be configured to close one or more contactors in the current path between the vehicle power supply and the at least one electrical energy storage module.

Optionally, the at least one control signal output to control charging of the electronic active roll control power supply from the vehicle power supply may comprise a control signal to enable the voltage converter.

Optionally, the one or more processors may collectively be configured to: receive a plurality of signals indicative of vehicle operating temperature; determine the lowest indication of vehicle operating temperature; and use the lowest indication of vehicle operating temperature as the vehicle operating temperature for comparison with the threshold.

Different sensors for measuring the vehicle operating temperature may be influenced by different factors. For example, if a vehicle has just been driven before engine off, certain vehicle components may have a higher temperature than the ambient temperature. Alternatively, due to their thermal properties, certain components may take longer to warm up than the ambient air. Therefore, using a lowest available indication of vehicle operating temperature ensures that the charging of the electronic active roll control power supply is delayed whenever this may be appropriate, even if this sometimes means that it is delayed when no delay is needed.

Optionally, the one or more processors may collectively be configured to determine that engine cranking is complete in dependence on: a transition from a first vehicle power mode corresponding to engine cranking to a second vehicle power mode corresponding to engine running; or a receipt of a signal indicating that the engine is running.

Optionally, the one or more processors may collectively be configured to, in dependence on determining that the vehicle operating temperature is above the threshold, cause charging of the electronic active roll control power supply.

According to a further aspect of the invention, there is provided an electronic active roll control power supply system comprising: an electronic active roll control power supply; and the control system as described herein.

The electronic active roll control power supply comprises at least one electrical energy storage module configured as a power buffer for one or more active roll stabilisers.

Optionally, the electronic active roll control power supply may comprise a voltage converter configured to receive input from a vehicle power supply.

Optionally, the at least one electrical energy storage module may be connected to an output of the voltage converter, for example via one or more contactors.

Optionally, the voltage converter may comprise a control circuitry configured to determine if a drop in the input voltage exceeds a predefined threshold and to transition to a standby state or shut down entirely after this occurs on more than a predefined number of occasions within a predefined time window. Optionally, the control circuitry may latch in this state.

Optionally, the voltage converter may be configured to step up an input voltage from the vehicle power supply.

According to a further aspect of the invention, there is provided a vehicle comprising the control system as described herein or the electronic active roll control power supply system as described herein.

According to a further aspect of the invention, there is provided a method of controlling an electronic active roll control power supply, the method comprising: receiving a signal indicative of a vehicle operating temperature; determining whether the vehicle operating temperature is below a threshold; and, in dependence on determining that the vehicle operating temperature is below a threshold, delaying charging of an electronic active roll control power supply from a vehicle power supply until engine cranking, powered by the vehicle power supply, is complete.

Optionally, delaying charging of the electronic active roll control power supply from the vehicle power supply may comprise at least one of: isolating or maintaining isolation of at least one electrical energy storage module of the electronic active roll control power supply from the vehicle power supply; placing or maintaining a voltage converter of the electronic active roll control power supply in a standby state.

Optionally, the method may comprise: receiving a plurality of signals indicative of vehicle operating temperature; determining the lowest indication of vehicle operating temperature; and using the lowest indication of vehicle operating temperature as the vehicle operating temperature for comparison with the threshold.

Optionally, the method may comprise: determining that engine cranking is complete in dependence on: a transition from a first vehicle power mode corresponding to engine cranking to a second vehicle power mode corresponding to engine running; or a receipt of a signal indicating that the engine is running.

Optionally, the method may comprise: in dependence on determining that the vehicle operating temperature is above the threshold or that engine cranking is complete, charging the electronic active roll control power supply.

Optionally, charging the electronic active roll control power supply may comprise at least one of: providing a current path between the vehicle power supply and at least one electrical energy storage module of the electronic active roll control power supply; enabling a voltage converter of the electronic active roll control power supply.

According to a further aspect of the invention, there is provided a control system for controlling an electronic active roll control power supply, the control system comprising one or more processors collectively configured to: output at least one control signal to control charging of the electronic active roll control power supply from a vehicle power supply; receive a signal indicative of a vehicle operating temperature; determine whether the vehicle operating temperature is below a threshold; and, in dependence on determining that the vehicle operating temperature is below a threshold, cause a charging of the electronic active roll control power supply to be delayed until the vehicle is in a travelable state.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to: output at least one control signal to control charging of the electronic active roll control power supply from a vehicle power supply; receive a signal indicative of a vehicle operating temperature; determine whether the vehicle operating temperature is below a threshold; and, in dependence on determining that the vehicle operating temperature is below a threshold, cause a charging of the electronic active roll control power supply to be delayed until the vehicle is in a travelable state.

According to another aspect of the invention, there is provided a method of controlling an electronic active roll control power supply, the method comprising: receiving a signal indicative of a vehicle operating temperature; determining whether the vehicle operating temperature is below a threshold; and, in dependence on determining that the vehicle operating temperature is below a threshold, delaying charging of an electronic active roll control power supply from a vehicle power supply until the vehicle is in a travelable state.

A travelable state is a state in which the vehicle can be driven, for example using output torque from the engine.

According to a further aspect of the invention there is provided computer readable instructions which, when executed by a computer, are arranged to perform any one or more of the methods described herein. According to a further aspect of the invention there is provided a non-transitory computer readable medium comprising computer readable instructions that, when executed by one or more electronic processors, causes the one or more electronic processors to carry out any one or more of the methods described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle as described herein;

FIG. 2 illustrates a schematic representation of an example of an electronic active roll control system;

FIG. 3 illustrates a schematic representation of an example of an electronic active roll control power supply;

FIG. 4 illustrates a schematic representation of an example of a control system;

FIG. 5 illustrates a schematic representation of an example of a non-transitory storage medium;

FIG. 6 illustrates a flowchart illustrating an example of a method; and

FIG. 7 illustrates a flowchart illustrating another example of a method.

### DETAILED DESCRIPTION

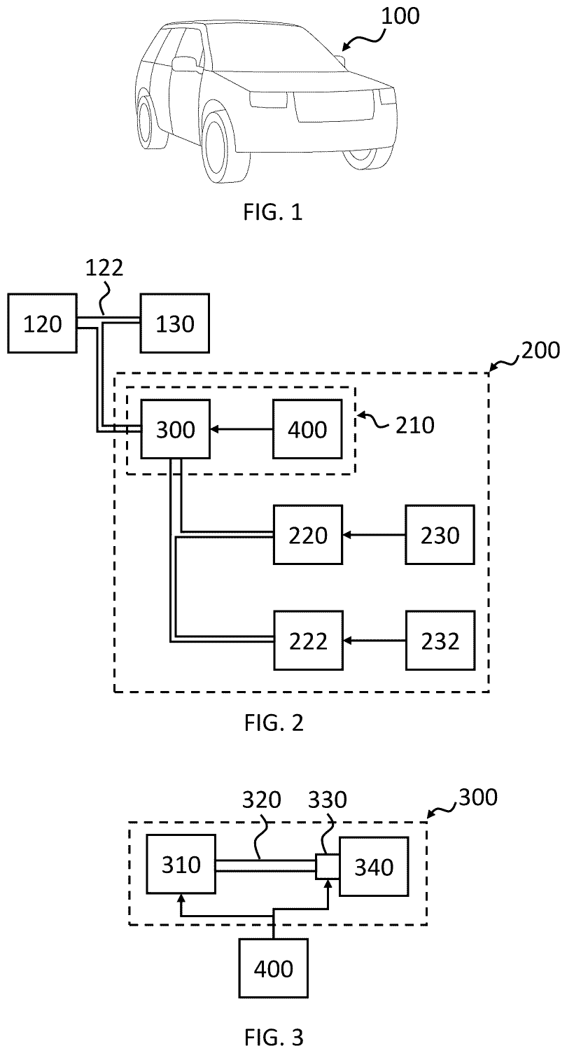

A vehicle 100 in accordance with an embodiment of the present invention is described herein with reference to the accompanying FIG. 1. In some, but not necessarily all examples, the vehicle 100 is a passenger vehicle, also referred to as a passenger car or as an automobile. In other examples, embodiments of the invention can be implemented for other applications, such as commercial vehicles.

With reference to FIG. 2, there is illustrated an electronic active roll control (eARC) system 200 of a vehicle, such as the vehicle 100 illustrated in FIG. 1.

The eARC system 200 may comprise one or more eARC actuators 220, 222 associated with different axles, such as front and rear axles, of the vehicle 100. Each eARC actuator 220, 222 may comprise an electric motor and, optionally, a gearbox. An active roll stabilizer is formed by connecting two parts of a split stabilizer bar with an eARC actuator. The eARC actuator applies torsion between the two parts of the stabilizer bar. The torsion applied counteracts a sensed roll torque.

The eARC system 200 may comprise one or more eARC actuator controllers 230, 232. The one or more eARC actuator controllers 230, 232 may independently control respective one or more eARC actuators 220, 222 to apply an amount of torsion to counteract the sensed roll torque.

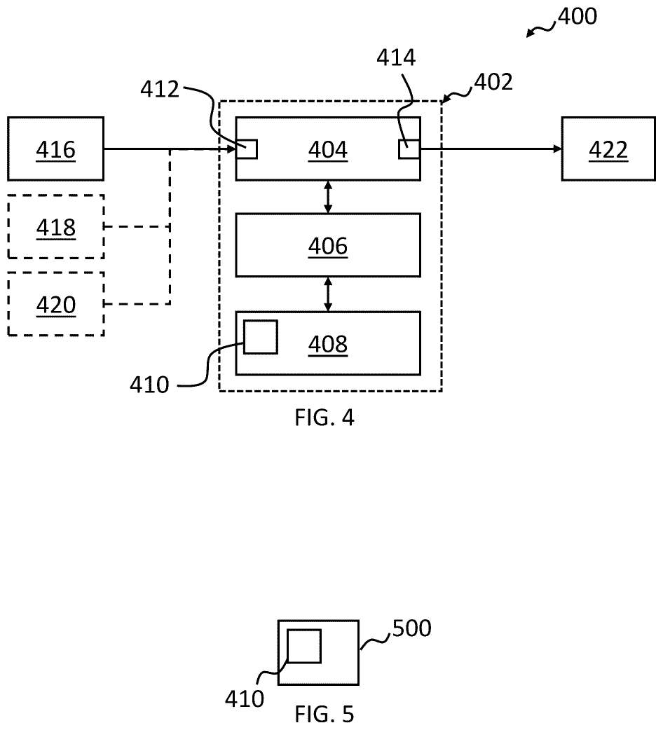

The eARC system 200 comprises an eARC power supply system 210. The one or more eARC actuators 220, 222 draw electrical power from the eARC power supply system 210. The eARC power supply system 210 is a dedicated power supply system for the one or more eARC actuators 220, 222. The eARC power supply system 210 comprises eARC power supply 300 and a control system 400 for controlling the eARC power supply 300, examples of which are described in more detail with reference to FIGS. 3 and 4 below.

The eARC power supply system 210 sources its power from a vehicle power supply 120. Other vehicle subsystems also draw power from the vehicle power supply 120. For example, a starter 130, used for engine cranking, also draws electrical power from the vehicle power supply 120. Here, engine cranking will be understood to comprise energizing the engine using a force external to the engine. Examples of the starter 130 include a starter motor or an integrated starter generator. Other vehicle subsystems which draw power from the vehicle power supply 120 can also include the fuel injection and ignition systems and accessories such as infotainment and comfort features.

In some but not necessarily all examples, different vehicle subsystems may draw electrical power from the vehicle power supply 120 in different vehicle power modes. Vehicle power modes are analogous to ignition switch positions and encompass the states entered through ignition switch positions but additionally encompass corresponding states in vehicles where the traditional ‘key barrel’ has been replaced with keyless entry and starting.

The vehicle power supply 120 may be a low voltage power supply and may distribute electrical power via a low voltage bus 122. The low voltage power supply 120 may be a 12V battery such as a starter battery.

With reference to FIG. 3, there is illustrated an example of an eARC power supply 300.

In this example, but not necessarily all examples, the eARC power supply 300 comprises at least one electrical energy storage module (EESM) 340. The at least one EESM 340 is configured as a power buffer for one or more active roll stabilisers, or more specifically for the one or more eARC actuators 220, 222 comprised in the one or more active roll stabilisers. In acting as a power buffer, the at least one EESM 340 decouples the eARC actuators' loads from the vehicle power supply 120 and provides a temporary store of energy which can be supplied to meet the eARC actuators' load demand. This helps to manage transient loads. This may also help to manage the situations where the power supplied by the vehicle power supply 120 and the eARC actuators' load demand are mismatched.

The at least one EESM 340 may be a battery, a capacitor, a supercapacitor, or any other suitable electrical accumulator.

In some but not necessarily all examples, the at least one EESM 340 may be rated to have a higher voltage than that of the vehicle power supply 120. For example, the at least one EESM 340 may be rated to 48V in contrast to the vehicle power supply's 12 V.

In such examples, the eARC power supply 300 comprises a voltage converter 310. The voltage converter 310 is a step-up (or boost) converter. However, it will be appreciated that the at least one EESM 340 could in some examples be rated to a lower voltage than the voltage of the vehicle power supply 120, in which case the voltage converter 310 would be a step-down (or buck) converter. The voltage convertor 310 is, in some examples, bi-directional and configured to step-up voltage to the at least one EESM 340 and step-down voltage from the at least one EESM 340, back to the vehicle power supply 120, enabling harvesting of excess energy from the eARC system 200. The voltage converter 310 is connected between the vehicle power supply 120 and the at least one EESM 340. The at least one EESM 340 is coupled to an output of the voltage converter 310. In some but not necessarily all examples, it is coupled via a bus 320, for example a higher (e.g., high or medium) voltage bus compared to the low voltage bus 122, and an isolation switch 330. The voltage bus 320 may, for example, be a 48V bus. The isolation switch 330 is arranged to enable isolation of the at least one EESM 340 from the bus 320. The isolation switch 330 may comprise one or more contactors.

The voltage converter 310 comprises control circuitry, which can be an integrated circuit, having a plurality of operational states including a standby state and at least one enabled state. In the standby state there is no voltage conversion and no direct current path between the input and output terminals of the voltage converter 310. In the at least one enabled state there is voltage conversion and a direct current path between the input and output terminals of the voltage converter 310. The operational state of the control circuitry may be controlled by the control system 400. However, it may also transition between operational states independently on the control system 400. For example, while in an enabled state, the control circuitry can be configured to determine the input voltage drops below a predefined threshold, for example 5V at 12V input terminals. Input voltage refers to the voltage at its input terminals, which are connected to the voltage bus 122. If the input voltage drops below the predefined threshold on more than a predefined number of occasions within a predefined time window, the control circuitry may transition to the standby state or shut down entirely and latch in this state. This may be done to prevent malfunction and protect the voltage converter 310 and connected loads such as the at least one EESM 340. In some examples, this cannot be unlatched without the intervention of a service technician. It is advantageous, therefore, to avoid circumstance where this drop in the input voltage may occur.

With reference to FIG. 4, there is illustrated a control system 400 for an eARC power supply 300, such as the example eARC power supply 300 illustrated in FIG. 3. The control system 400 comprises one or more controllers 402.

The control system 400 may be configured to receive vehicle operating temperature data from at least one temperature sensor 416 and, in dependence on the temperature data, select a criterion for initiating charging of the eARC power supply 300. A criterion which may be selected comprises the completion of engine cranking. In order to determine whether engine cranking is complete, the control system 400 can be configured to receive data indicative of a current vehicle power mode or of a current engine status from another controller 418 or from sensors 420 monitoring the engine. The control system 400 may then output at least one control signal to control charging of the eARC power supply 300 from the vehicle power supply 120.

The control system 400 as illustrated in FIG. 4 comprises one controller 402, although it will be appreciated that this is merely illustrative. The controller 402 comprises processing means 406 and memory means 408. The processing means 406 may be one or more electronic processing device 406 which operably execute computer-readable instructions. The memory means 408 may be one or more memory device. The memory means 408 is electrically coupled to the processing means 406. The memory means 408 is configured to store instructions, and the processing means 406 is configured to access the memory means 408 and execute the instructions stored thereon.

The controller 402 comprises an input means 412 and an output means 414. The input means 412 may comprise an electrical input of the controller 402. The output means 414 may comprise an electrical output of the controller 402. The controller 402 may have an interface 404 comprising an electrical input/output I/O 412, 414, or an electrical input 412, or an electrical output 414, for receiving information and interacting with external components. The input 412 is arranged to receive a vehicle operating temperature signal from a temperature sensor. The vehicle operating temperature signal is an electrical signal which is indicative of a vehicle operating temperature. The output 414 is arranged to output at least one control signal for controlling charging of the eARC power supply 300 from the vehicle power supply 120.

FIG. 5 illustrates a non-transitory computer-readable storage medium 500 comprising the instructions (computer software).

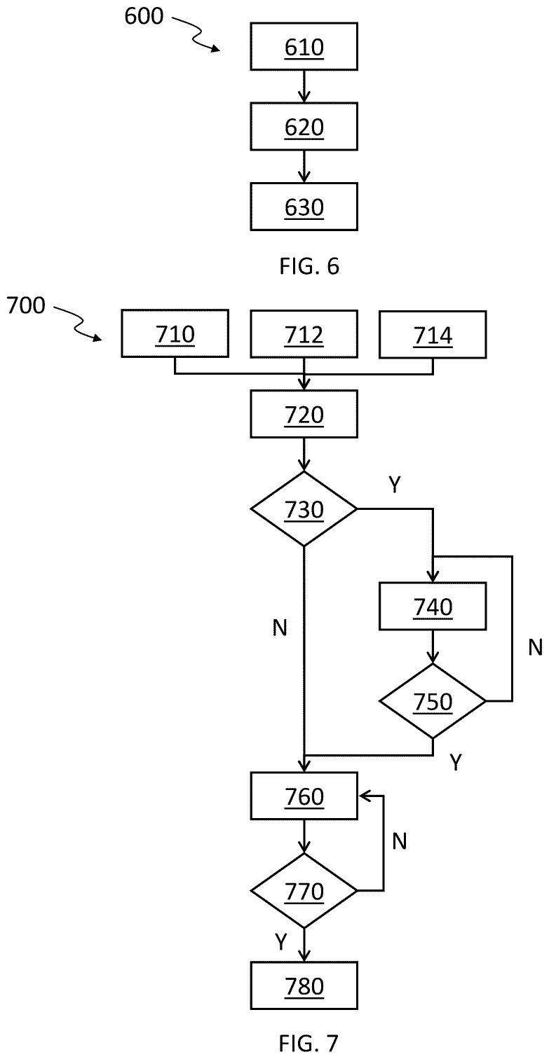

FIG. 6 illustrates a method 600 according to an embodiment of the invention. The method 600 is a method of controlling an electronic active roll control power supply, such as the electronic active roll control power supply 310 illustrated in FIG. 3. The method 600 may be performed by the control system 400 illustrated in FIG. 4. In particular, the memory 408 may comprise computer-readable instructions 410 which, when executed by the processor 406, perform the method 600.

The method 600 is illustrated by blocks 610-630 in FIG. 6.

At block 610, the method 600 comprises receiving an indication of a vehicle operating temperature.

The vehicle operating temperature may be a temperature of a component or fluid of the vehicle 100 or an ambient temperature. The vehicle operating temperature may be any temperature which affects the energy available from the vehicle power supply 120 for charging eARC power supply 300. The energy available can be directly affected by the capability of the vehicle power supply 120, which varies with temperature. Therefore, the vehicle operating temperature may be a temperature of the vehicle power supply 120. The vehicle operating temperature may be an average of temperatures measured for different parts of the vehicle power supply 120. The energy available can also be affected by the load demand of other vehicle subsystems which draw power from the vehicle power supply 120. Accordingly, the vehicle operating temperature may be a temperature associated with these other vehicle subsystems, such as a temperature which affects the load demand of the other vehicle subsystems. For example, the vehicle operating temperature may be a temperature of the engine oil, which can affect the load demand of the starter 130. The vehicle operating temperature may be a minimum temperature from among one or more component temperatures, one or more fluid temperatures, or ambient temperature.

If the method 600 is performed by the control system 400, then block 610 is implemented by receiving a signal indicative of a vehicle operating temperature. The vehicle operating temperature used in the method 600 may be one indicated by a signal which is processed by the control system 400 for at least one other purpose such that adaptations to the vehicle wiring harness to facilitate implementation of the method 600 may be avoided.

At block 620, the method 600 comprises determining whether the vehicle operating temperature is below a threshold.

In some but not necessarily all examples, at block 620, the method 600 may comprise determining whether the vehicle operating temperature is at or below the threshold.

The threshold can be derived from experimental data, theoretical modelling, or a combination thereof aimed at determining a value of the considered vehicle operating temperature which correlates with failure (or frequent failure) to charge the eARC power supply 300 upon the vehicle 100 exiting a sleep/standby state.

At low temperatures, there may be insufficient energy available for charging the eARC power supply 300 because of a reduction in the overall capacity of the vehicle power supply 120 and an increase in the energy needed to crank the engine, for example due to engine oil being more viscous.

If the method 600 is implemented in respect of the eARC power supply 300 of FIG. 3, the temperature threshold can be derived from experimental data, theoretical modelling, or a combination thereof aimed at determining a value of the considered vehicle operating temperature which correlates with the voltage level at the input (low voltage) terminals of the voltage converter 310 dropping (or frequently dropping) under a predefined voltage threshold during engine cranking as a result of the high current demands of cranking. The predefined voltage threshold may be the operational value at which behaviour of the voltage converter 310 becomes unpredictable and it needs to be shut down or enter standby mode in order to protect the voltage converter 310 and connected loads such as the at least one EESM 340. By way of a non-limiting example, the temperature threshold may be 10° C.

At block 630, the method 600 comprises, in dependence on determining that the vehicle operating temperature is below the threshold, delaying charging of the eARC power supply 300 from the vehicle power supply 120 until engine cranking, powered by the vehicle power supply 120, is complete.

In some but not necessarily all examples, at block 630, the method 600 may comprise, in dependence on determining that the vehicle operating temperature is at or below the threshold, delaying charging of the eARC power supply 300 from the vehicle power supply 120 until engine cranking, powered by the vehicle power supply 120, is complete.

More generally, the method 600 can comprise delaying charging of the eARC power supply 300 from the vehicle power supply 120 until the vehicle 100 is in an engine running state. Where engine starting is achieved other than by cranking, for example by a fuel-starting strategy where fuel is injected into a cylinder with a piston stopped on its power stroke and is igniting to start energization of the engine. This too draws power from the vehicle power supply 120 and may thus leave an energy deficit for charging of the eARC power supply 300.

More generally still, the method 600 can comprise delaying charging of the eARC power supply 300 from the vehicle power supply 120 until the vehicle 100 is in a travelable state. A travelable state is a state in which the vehicle 100 can be driven, for example using output torque from the engine.

If the method 600 is performed by the control system 400, then charging of the eARC power supply 300 is controlled by at least one control signal which the control system 400 is configured to output.

The eARC power supply 300 may comprise a plurality of components in need of control in order for charging to occur. Therefore, the control system 400 is in some but not necessarily all examples configured to output a plurality of suitable control signals.

In some but not necessarily all examples, delaying charging of the eARC power supply 300 may comprise delaying output of the at least one control signal until engine cranking is complete.

In some other but not necessarily all other examples, delaying charging of the eARC power supply 300 may comprise using the at least one control signal to cause the eARC power supply 300 to be in a standby state until engine cranking is complete and then adapting the at least one control signal to cause the eARC power supply 300 to transition into a charging state.

In some but not necessarily all examples, controlling the eARC power supply 300 of FIG. 3 according to the method 600 may comprise controlling the at least one EESM 340.

For example, causing the charging of the eARC power supply 300 of FIG. 3 to be delayed comprises isolating or maintaining isolation of the at least one EESM 340 from the vehicle power supply 120. Charging the eARC power supply 300 of FIG. 3 comprises providing a current path between the vehicle power supply 120 and the at least one EESM 340. The current path can be provided by closing the isolation switch 330. In such examples, at least one control signal output by the control system 400 controls the opening and closing of the isolation switch 330.

Additionally or alternatively, controlling the eARC power supply 300 of FIG. 3 according to the method 600 comprises controlling the voltage converter 310.

For example, causing the charging of the eARC power supply 300 of FIG. 3 to be delayed may comprise placing or maintaining the voltage converter 310 in a standby state. In the standby state there is no voltage conversion and no direct current path between the input and output terminals of the voltage converter 310. Charging the eARC power supply 300 of FIG. 3 may comprise enabling the voltage converter 310. In the enabled state there is voltage conversion and a direct current path between the input and output terminals of the voltage converter 310. In such examples, at least one control signal output by the control system 400 controls whether the voltage converter 310 is enabled or in a standby state.

FIG. 7 illustrates a further example of the method 600. This further example of the method 600 is illustrated with method 700 and by blocks 710-780 in FIG. 7.

At blocks 710, 712 and 714, the method 700 comprises receiving a plurality of indications of vehicle operating temperature. The indications may be received as separate input signals to the control system 400.

At block 720, the method 700 comprises determining the lowest indication of vehicle operating temperature.

The lowest indication of vehicle operating temperature is subsequently used as the vehicle operating temperature for comparison with a threshold at block 730. The threshold and the comparison are as described in referenced to block 620 of the method 600 of FIG. 6.

In dependence on determining that the vehicle operating temperature is at or below the threshold (the ‘Y’ path from block 730), the method 700 proceeds to block 740.

At block 740, the method 700 comprises receiving an indication of a current vehicle power mode or of a current engine status. The indication may be received as an input signal to the control system 400.

At block 750, the method 700 comprises determining whether engine cranking is complete. The determination is made in dependence on the indication of a current vehicle power mode or of a current engine status received at block 740.

In some but not necessarily all examples, engine cranking can be determined to be complete in dependence on a transition from a first vehicle power mode corresponding to engine cranking to a second vehicle power mode corresponding to engine running.

In some but not necessarily all examples, engine cranking can be determined to be complete in dependence on a receipt of at least one signal indicating that the engine is running. The at least one signal may originate from sensors monitoring the engine and can pertain to, for example, crankshaft speed or feedback from ignition and fuel systems.

In dependence on determining that engine cranking is not complete (the ‘N’ path from block 750), the method 700 returns to block 740. The method 700 loops over blocks 740 and 750 until it is determined that engine cranking is complete.

In dependence on determining that engine cranking is complete (the ‘Y’ path from block 750), the method 700 proceeds to block 760, at which charging of the eARC power supply 300 begins. Accordingly, charging of the eARC power supply 300 is delayed until engine cranking is complete, as described in reference to block 630 of the method 600 of FIG. 6.

The method 700 also proceeds to block 760 in dependence on determining that the vehicle operating temperature is above the threshold (the ‘N’ path from block 730).

Accordingly, in dependence on determining that the vehicle operating temperature is above the threshold or that engine cranking is complete, the method 700 comprises charging the eARC power supply 300.

In some but not necessarily all examples, for the method 700 to proceed to block 760 it is also required that the vehicle is not in a sleep/standby state, that the eARC power supply 300 is not in service mode, and that the eARC power supply 300 is not exhibiting faults corresponding to communication loss or loss of function, whether temporary or permanent.

At block 760, the method 700 comprises controlling the voltage converter 310 to bring the voltage on the bus 320 up to a target voltage equal to the voltage currently stored in the at least one EESM 340. Once the voltage on the bus 320 is within a predefined offset, for example 2V, of the voltage currently stored in the at least one EESM 340, the isolation switch 330 is controlled to close, providing a current path from the bus 320 to the at least one EESM 340 so that charging of the at least one EESM 340 begins. The isolation switch 330 is not closed until the voltage on the bus 320 is within a predefined offset of the voltage currently stored in the at least one EESM 340 in order to avoid inrush current across the isolation switch 330 when it is closed. The control system 400 may perform the method 700 at block 760 by output of suitable control signals respectively to the voltage converter 310 and to the isolation switch 330.

At block 770, the method 700 comprises determining whether the at least one EESM 340 has been charged up to a target voltage. The target voltage may correspond to a minimum operating voltage for the eARC actuators 220, 222 or at least a minimum voltage the eARC actuators 220, 222 require to deliver an expected level of anti-roll torque. Whether the at least one EESM 340 has been charged up to the target voltage may be determined in dependence on a measurement of the voltage at the input terminal to the at least one EESM 340.

In some but not necessarily all examples, when the vehicle 100 enters a sleep/standby state, the control system 400 may be configured to bring the at least one EESM 340 up to a predefined storage voltage. In some but not necessarily all examples, the predefined storage voltage may be equal to or greater than the target voltage considered at block 770. Therefore, the time required to charge the at least one EESM 340 up to the target voltage may be zero or small if the vehicle 100 is not left in a sleep/standby state for too many days. It will therefore be appreciated that in some scenarios, the time between completion of engine cranking and the eARC actuators 220, 222 being operational may be dependent on the time to raise the voltage on the bus 320 to within a predefined offset of the voltage stored in the at least one EESM 340.

It is noted that when the vehicle 100 enters a sleep/standby state and after the voltage level in the at least one EESM 340 has been brought up to the predefined storage voltage, the control system 400 may be configured to output a control signal to cause the voltage converter 310 to transition into a standby state and a control signal to open the isolation switch 330 to cut off the current path between the bus 320 and the at least one EESM 340. Once the isolation switch 330 is open, the control system 400 is configured to discharge the bus 320.

Once it is determined that the at least one EESM 340 has been charged up to a target voltage (the ‘Y’ path from block 770), the method 700 proceeds to block 780.

At block 780, the method 700 comprises permitting the eARC system 200 to draw energy from the at least one EESM 340 to power the eARC actuators 220, 222. The voltage converter 310 is caused to operate to maintain the voltage stored in the at least one EESM 340 within a target operating range. This may be higher than the target voltage considered at block 770. The voltage converter 310 is controlled to respond to the drop in voltage in the at least one EESM 340, caused by the drawing of energy to power the eARC actuators 220, 222, to bring the voltage back up into the target operating range. In some but not necessarily all examples, the voltage converter 310 is controlled to operate in this mode by its control circuitry in response to a request to operate in this mode from the control system 400.

It will be appreciated that various changes and modifications can be made to the present invention without departing from the scope of the present application.

It is to be understood that the or each controller 402 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 402 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 402 to implement the control techniques described herein (including some or all of the functionality required for the method(s) described herein). The set of instructions 410 could be embedded in said one or more electronic processors 406 of the controller 402; or alternatively, the set of instructions 410 could be provided as software to be executed in the controller 402. A first controller or control unit may be implemented in software run on one or more processors. One or more other controllers or control units may be implemented in software run on one or more processors, optionally the same one or more processors may be the first controller or control unit. Other arrangements are also possible.

The, or each, electronic processor 406 may comprise any suitable electronic processor (e.g., a microprocessor, a microcontroller, an ASIC, etc.) that is configured to execute electronic instructions 410. The, or each, electronic memory device 408 may comprise any suitable memory device and may store a variety of data, information, threshold value(s), lookup tables or other data structures, and/or instructions therein or thereon. In an embodiment, the memory device 408 has information and instructions for software, firmware, programs, algorithms, scripts, applications, etc. stored therein or thereon that may govern all or part of the methodology described herein. The processor, or each, electronic processor 406 may access the memory device 408 and execute and/or use that or those instructions and information to carry out or perform some or all of the functionality and methodology described herein.

The at least one memory device 408 may comprise a computer-readable storage medium (e.g. a non-transitory or non-transient storage medium) that may comprise any mechanism for storing information in a form readable by a machine or electronic processors/computational devices. Examples of the form include, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

It will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and/or method steps of the present invention may equally be implemented by way of non-programmable hardware, such as by way of non-programmable ASIC, Boolean logic circuitry, etc.

The blocks illustrated in the FIGS. 6 and 7 may represent steps in a method and/or sections of code in the computer program 410. The illustration of a particular order to the blocks does not necessarily imply that there is a required or preferred order for the blocks and the order and arrangement of the block may be varied. Furthermore, it may be possible for some steps to be omitted.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1. A control system for controlling an electronic active roll control power supply, the control system comprising one or more processors collectively configured to:
output at least one control signal to control charging of the electronic active roll control power supply from a vehicle power supply;
receive a signal indicative of a vehicle operating temperature;
determine whether the vehicle operating temperature is below a threshold; and
in dependence on determining that the vehicle operating temperature is below the threshold, cause the charging of the electronic active roll control power supply to be delayed until engine cranking, powered by the vehicle power supply, is complete.

2. The control system of claim 1, wherein the electronic active roll control power supply comprises at least one electrical energy storage module, the at least one electrical energy storage module being configured as a power buffer for one or more active roll stabilisers.

3. The control system of claim 2, wherein the electronic active roll control power supply further comprises a voltage converter, the voltage converter being connected between the vehicle power supply and the at least one electrical energy storage module.

4. The control system of claim 2, wherein causing the charging of the electronic active roll control power supply to be delayed comprises isolating or maintaining isolation of the at least one electrical energy storage module from the vehicle power supply.

5. The control system of claim 3, wherein causing the charging of the electronic active roll control power supply to be delayed comprises placing or maintaining the voltage converter in a standby state.

6. The control system of claim 2, wherein the at least one control signal to control charging of the electronic active roll control power supply from the vehicle power supply comprises a control signal to provide a current path between the vehicle power supply and the at least one electrical energy storage module.

7. The control system of claim 3, wherein the at least one control signal to control charging of the electronic active roll control power supply from the vehicle power supply comprises a control signal to enable the voltage converter.

8. The control system of claim 1, wherein the one or more processors are collectively configured to:
receive a plurality of signals indicative of vehicle operating temperature;
determine a lowest indication of vehicle operating temperature; and
use the lowest indication of vehicle operating temperature as the vehicle operating temperature for comparison with the threshold.

9. The control system of claim 1, wherein the one or more processors are collectively configured to determine that engine cranking is complete in dependence on:
a transition from a first vehicle power mode corresponding to engine cranking to a second vehicle power mode corresponding to an engine running; or
a receipt of a signal indicating that the engine is running.

10. An electronic active roll control power supply system comprising:
at least one electrical energy storage module configured as a power buffer for one or more active roll stabilisers; and
the control system of claim 1.

11. The electronic active roll control power supply system of claim 10, further comprises a voltage converter configured to receive input from the vehicle power supply and wherein the at least one electrical energy storage module is coupled to an output of the voltage converter; wherein the voltage converter is configured to step up an input voltage from the vehicle power supply.

12. A vehicle comprising the control system of claim 1.

13. A vehicle comprising the electronic active roll control power supply system of claim 10.

14. A method of controlling an electronic active roll control power supply, the method comprising:
receiving a signal indicative of a vehicle operating temperature;
determining whether the vehicle operating temperature is below a threshold; and
in dependence on determining that the vehicle operating temperature is below the threshold, delaying charging of the electronic active roll control power supply from a vehicle power supply until engine cranking, powered by the vehicle power supply, is complete.

15. The method of claim 14, wherein delaying charging of the electronic active roll control power supply from the vehicle power supply comprises at least one of:
isolating or maintaining isolation of at least one electrical energy storage module of the electronic active roll control power supply from the vehicle power supply;
placing or maintaining a voltage converter of the electronic active roll control power supply in a standby state.

16. The method of claim 14, comprising:
receiving a plurality of signals indicative of vehicle operating temperature;
determining a lowest indication of vehicle operating temperature; and
using the lowest indication of vehicle operating temperature as the vehicle operating temperature for comparison with the threshold.

17. The method of claim 14, comprising determining that engine cranking is complete in dependence on:
a transition from a first vehicle power mode corresponding to engine cranking to a second vehicle power mode corresponding to an engine running; or
a receipt of a signal indicating that the engine is running.

18. The method of claim 14, comprising, in dependence on determining that the vehicle operating temperature is above the threshold or that engine cranking is complete, charging the electronic active roll control power supply.

19. The method of claim 18, wherein charging the electronic active roll control power supply comprises at least one of:
providing a current path between the vehicle power supply and at least one electrical energy storage module of the electronic active roll control power supply;
enabling a voltage converter of the electronic active roll control power supply.

20. A non-transitory computer readable medium comprising computer readable instructions that, when executed by one or more electronic processors, causes the one or more electronic processors to carry out the method of claim 14.
